(19) United States
(12) Patent Application Publication
(10) Pub. No.: US 2026/0119268 A1
(43) Pub. Date: Apr. 30, 2026

(54) ADAPTIVE RESOURCE MANAGEMENT FOR MULTI-CLUSTER ENVIRONMENTS

(71) Applicant: Dell Products L.P., Round Rock, TX (US)

(72) Inventors: Haijun ZHONG, Shanghai (CN); Xiaojun WU, Shanghai (CN); Donald MACE, Mashpee, MA (US)

(73) Assignee: Dell Products L.P., Round Rock, TX (US)

(21) Appl. No.: 18/933,592

(22) Filed: Oct. 31, 2024

(51) Int. Cl. G06F 9/50

(52) U.S. Cl. CPC G06F 9/5072; G06F 9/5044

(57) ABSTRACT

Disclosed methods for adaptive management in a multi-cluster environment perform operations including maintaining an available resource pool comprising one or more resources available for use in at least one cluster selected from a plurality of clusters corresponding to a multi-cluster environment and detecting a request for multi-cluster management. The request indicates a multi-cluster management task. The operations include analyzing the request to identify needed resources, if any, required for the multi-cluster management task, determining whether the available resource pool includes sufficient suitable resources for the needed resources, if any, and responsive to determining the available resource pool includes sufficient suitable resources, performing the multi-cluster management task. Performing the multi-cluster management task may include allocating a selected resource from the available pool to a targeted cluster and removing the selected resource from the pool of available resource.

### TECHNICAL FIELD

The present disclosure is in the field of systems management and, more specifically, management of multi-cluster environments.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Two or more information handling systems may be implemented with hyperconverged infrastructure (HCI) appliances that may feature tightly integrated compute, storage, networking, and central management features and services. Commercially distributed examples of HCI appliances include the VxRail family of HCI appliances from Dell Technologies.

HCI appliances are capable of supporting multiple computing clusters. A computing cluster may refer to a group of two or more connected computers that function as a single system to provide services and perform tasks, etc., more reliably and efficiently, and in a more scalable manner, than a single monolithic system.

Management of multi-cluster environments can be challenging management environment, each cluster may have various storage, network, and even cluster configuration options. Furthermore, if the multi-cluster serves multiple purposes, the system on each work node may be different, including the operating system. In such environments, it is generally challenging to implement a management system able to coordinate computing resources and initialize computing resources for different clusters and serve for varied purposes in a convenient and efficient manner.

### SUMMARY

Disclosed methods and systems provide adaptive resource management for multi-cluster environments. In at least some embodiments, disclosed resource management features may maintain a pool of available resources and access the resource pool in response to management requests, from individual clusters, to perform various management tasks including, as representative examples, adding a new node to an existing cluster, removing an existing node from an existing cluster, and creating an entirely new cluster from available resources in the resource pool.

The initialization of nodes in a multi-cluster management environment is qualitatively different from conventional system initialization. For example, in a multi-cluster management environment, each cluster may have unique storage, network, and cluster configuration options. In addition, for any multi-cluster environment that addresses multiple functions or purposes, the configuration of each node may differ considerably, including the operating system deployed. For at least these reasons, it is challenging to implement a management system with functionality sufficient to coordinate resources among individual clusters and initialize resources targeted for different clusters tasked with responsibility for disparate functions and services.

In one aspect, disclosed information handling systems and method perform or include operations including maintaining an available resource pool comprising one or more resources available for use in at least one cluster selected from a plurality of clusters corresponding to a multi-cluster environment and detecting a request for multi-cluster management, wherein the request indicates a multi-cluster management task. The adaptive multi-cluster management operations include analyzing the request to identify needed resources, if any, required for the multi-cluster management task, determining whether the available resource pool includes sufficient suitable resources for the needed resources, if any, and responsive to determining the available resource pool includes sufficient suitable resources, performing the multi-cluster management task. The multi-cluster management task includes allocating a selected resource from the available pool to a targeted cluster and removing the selected resource from the pool of available resource.

In at least some embodiments, performing the task includes initializing an available resource for use as a new node in a targeted cluster selected from the plurality of clusters. Initializing the available resource includes installing an operating system suitable for the new node within the targeted cluster. The operating system installed may differ between any pair of nodes in the cluster, e.g., a Windows OS for one node and a Linux-based OS for another cluster.

Initializing a node may include configuring the node in accordance with cluster-specific provisioning criteria such as cluster-specific compute requirements, cluster-specific storage requirements, cluster-specific network requirements, and cluster-specific configuration options.

The multi-cluster environment includes at least one cluster implemented in a hyperconverged infrastructure (HCI) appliance. Representative multi-cluster management tasks disclosed herein include: an add-node task to add a resource from the available resource pool as a new node in an existing cluster, a remove-node task to remove an existing node from an existing cluster and assign the removed node to the available resource pool, and a create-cluster task to create a new cluster from two or more nodes in the available resource pool. The create-cluster task may include building a new cluster control plane for connecting to nodes allocated to the new cluster.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a representative multi-cluster environment including a resource management module in accordance with disclosed adaptive management features;

FIGS. 2-4 illustrate represent three representative management task scenarios for a multi-cluster resource management module;

FIG. 5 is a flow diagram depiction of a representative method for managing a multi-cluster environment; and

FIG. 6 illustrates features of a representative information handling system suitable for use in conjunction with a disclosed management.

### DETAILED DESCRIPTION

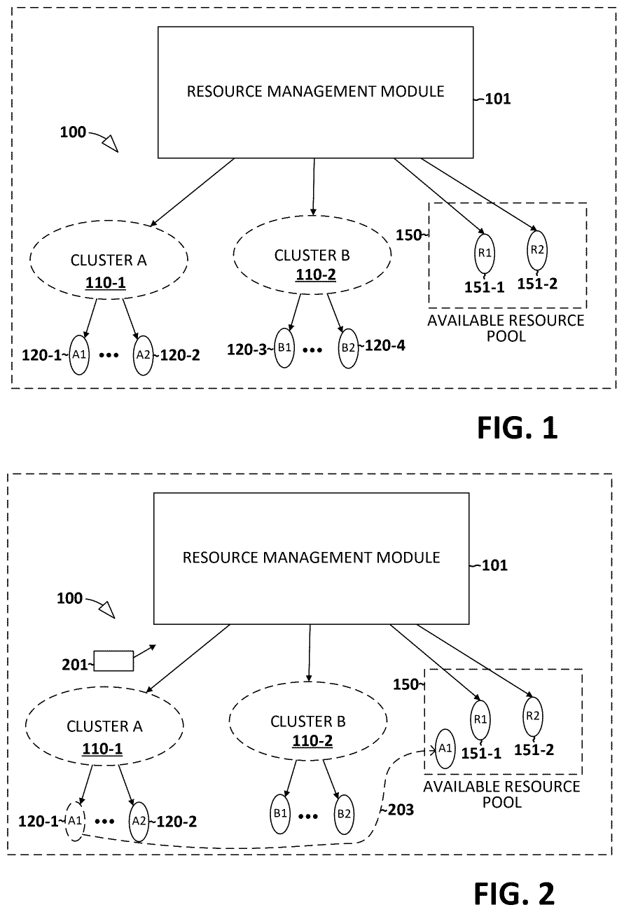

Exemplary embodiments and their advantages are best understood by reference to FIGS. 1-6, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 depicts a representative multi-cluster management environment 100, also referred to herein simply as multi-cluster 100. As depicted in FIG. 1, multi-cluster 100 includes a multi-cluster resource management module, referred to herein more simply as resource management module 101, configured to manage a plurality of independent and distinct multi-node clusters 110, two of which are illustrated in FIG. 1 as Cluster A (110-1) and Cluster B (110-2). Each multi-node cluster 110 illustrated in FIG. 1 includes two or more information handling nodes, referred to herein simply as nodes 120. Cluster A (110-1), as depicted in FIG. 1, includes Node A1 (120-1) and Node A2 while Cluster B (110-2) includes Node B1 (120-3) and Node B2 (120-4).

In at least some embodiments, each multi-node cluster 110 comprises a group of nodes that collectively contribute to a desired result and each node 120 corresponds to a single physical or virtual information handling resource. Nodes 120 may include one or more compute nodes, storage nodes, network nodes, hybrid nodes including converged infrastructure nodes. As depicted in FIG. 1, the multi-node clusters 110 may be implemented within a hyperconverged infrastructure (HCI) appliance, such as any of the VxRail family of HCI appliances from Dell Technologies.

The illustrated multi-cluster 100 further includes an available resource pool 150 coupled to resource management module 101. The available resource pool 150 depicted in FIG. 1 includes one or more information handling resources including available resources R1 (151-1) and R2 (151-2). Available resources 151 may include compute, storage, and/or network resources available for allocation to any suitable multi-node cluster 110 within multi-cluster 100.

Resource management module 101 provides adaptive resource management to multi-cluster 100 by, at least in part, performing various multi-cluster management tasks. Generally, whenever resource management module 101 detects a multi-cluster management task request from an existing node and cluster, the request is analyzed to determine what resources are needed to complete the task and what resources are present in the available resource pool 300. If there are sufficient available resources suitable for the requested task, the task is performed and the allocation of resources between the shared resource pool and the active clusters and nodes is updated accordingly. In the context of multi-cluster environments, the multi-task management resource beneficially supports initialization of available resources prior to delivery to the requesting cluster or node. This initialization may include installing a particular OS image as well as initializing various configuration settings. Representative examples of adaptive resource management tasks are illustrated in FIGS. 2-4 and the accompanying description set forth below.

FIG. 2 illustrates a multi-cluster adaptive resource management task referred to herein as a remove-node task to remove an existing node from multi-cluster 100. Specifically, FIG. 2 depicts resource management module 101 detecting a multi-cluster management request 201 from node A1 (120-1). In this illustrative example, cluster A (110-1) has determined that is appropriate to release a node 120, e.g., node A1 (120-1). In this particular case, because the requested task does not require any available resources, it is not necessary to search available resource pool 150 for a suitable resource. Upon detecting multi-cluster management request 201 and determining that multi-cluster management request 201 does not require available resources, resource management module 101 executes a remove-node task for the node identified in the request, e.g., node A1 120-1. FIG. 2 depicts the reassignment/removal 203 of node A1 120-1 from Cluster A 110-1 and the corresponding delivery or transfer of node A1 (120-1) to available resource pool 150. Node A1 (120-1) is re-designated as an available resource 151 in available resource pool 150. In this example, an available resource 151 may refer to a resource in available resource pool 150 that is awaiting configuration and assignment or allocation to a multi-node cluster 110 in multi-cluster 100.

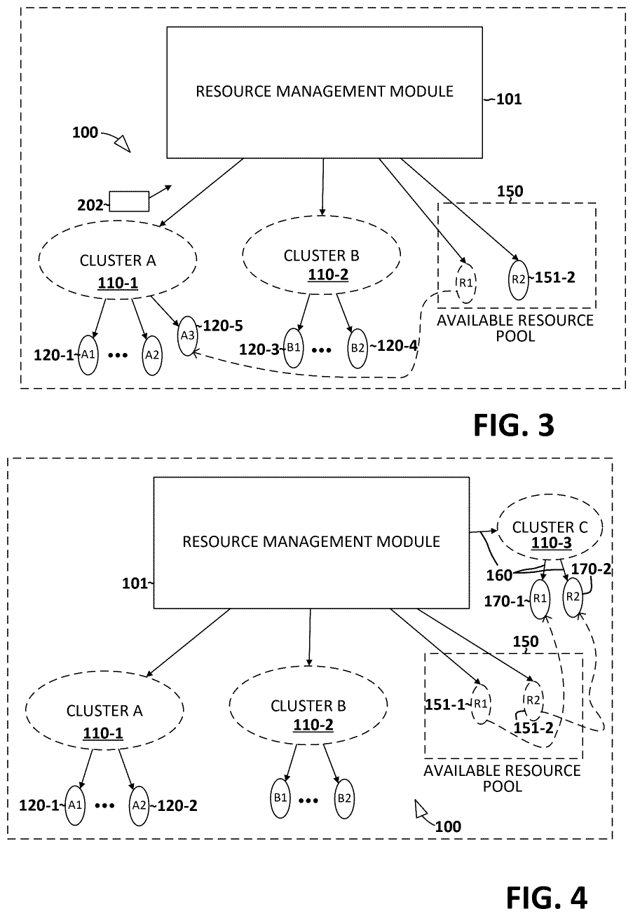

Moving on, FIG. 3 illustrates representative multi-cluster management operations for adding an available resource 151 from available resource pool 150 to an existing cluster, e.g., cluster A (110-1). As depicted in FIG. 2, cluster A (110-1) sends a request 202 to resource management module 101. Upon receiving request 202 from Cluster A (110-1), resource management module 101 searches for an available computing resource 151 within available resource pool 150. Upon finding a sufficiently provisioned and otherwise suitable available resource, e.g., available resource R1 (151-1), resource management module 101 may then prepare an initialization payload suitable for the requested resource and initialize the resource. The initialized resource may then be allocated and connected to cluster 110-1 as node 120-5.

Moving on, FIG. 4 illustrates a representative multi-cluster task for building an entirely new multi-node cluster 110-3 from available resources 151 in available resource pool 150. In addition to performing the steps associated with adding an available resource as a node in an existing multi-node cluster 110 as described in the preceding disclosure of FIG. 3, the multi-cluster management task depicted in FIG. 4 includes the building of a cluster control plane 160, enabling resource management module 101 to connect and communicate with the nodes of the new multi-node cluster 110-3.

The representative resource management operations illustrated in FIGS. 2-4 may include with the receipt and analysis of a resource request from one of the existing multi-node clusters. The resource management module 101 may respond to the request and the resulting analysis by preparing a payload appropriate for the requested configuration or resource. Resource management module 101 may then activate the available resource by sending the payload and connecting the configured available resource to the applicable node in the applicable multi-node cluster.

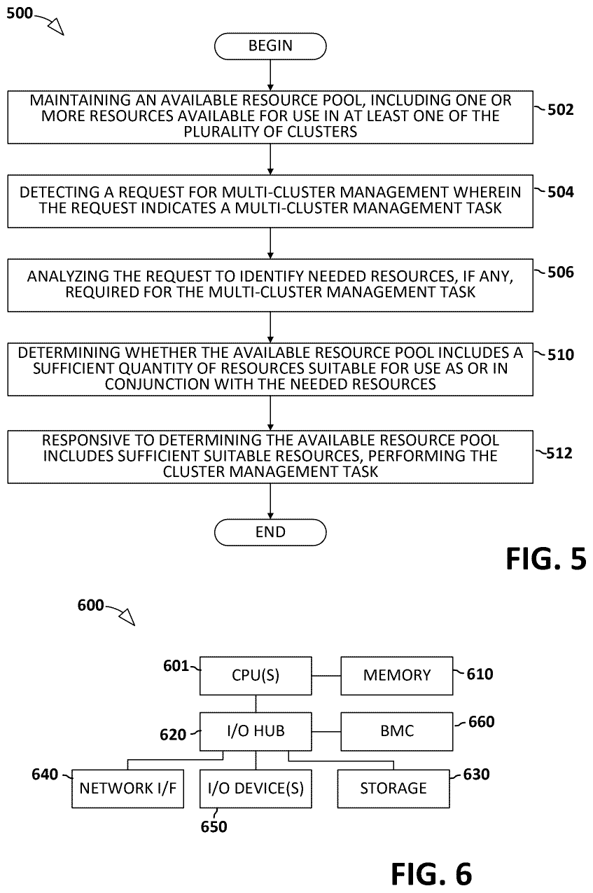

Referring now to FIG. 5, a flow diagram illustrates a representative method 500 for performing adaptive management in a multi-cluster environment. As depicted in FIG. 5, method 500 includes maintaining (502) an available resource pool, including one or more resources available for use in at least one cluster selected from a plurality of clusters corresponding to a multi-cluster environment. Resources in the available resource pool may include resources that were previously allocated to a particular node in a particular cluster.

The method 500 depicted in FIG. 5 further includes detecting (504) a request for multi-cluster management, wherein the request indicates a multi-cluster management task, and analyzing (506) the request to identify needed resources, if any, required for the multi-cluster management task. No resources from the available resource pool may be needed for certain tasks including, as at least one example, a remove-node task for removing an existing node in an existing cluster to the available resource pool.

The method 500 depicted in FIG. 5 may further include determining (510) whether the available resource pool includes sufficient resources suitable for use as or in conjunction with the needed resources, if any. In response to determining the available resource pool includes sufficient suitable resources, the multi-cluster management task may be performed (512). In at least some embodiments, performing the multi-cluster management task may include allocating (514) a selected resource from the available resource pool to a targeted cluster and removing (516) the selected resource from the available resource pool.

Referring now to FIG. 6, any one or more of the elements illustrated in FIG. 1 through FIG. 5 may be implemented as or within an information handling system exemplified by the information handling system 600 illustrated in FIG. 6. The illustrated information handling system includes one or more general purpose processors or central processing units (CPUs) 601 communicatively coupled to a memory resource 610 and to an input/output hub 620 to which various I/O resources and/or components are communicatively coupled. The I/O resources explicitly depicted in FIG. 6 include a network interface 640, commonly referred to as a NIC (network interface card), storage resources 630, and additional I/O devices, components, or resources 650 including as non-limiting examples, keyboards, mice, displays, printers, speakers, microphones, etc. The illustrated information handling system 600 includes a baseboard management controller (BMC) 660 providing, among other features and services, an out-of-band management resource which may be coupled to a management server (not depicted). In at least some embodiments, BMC 660 may manage information handling system 600 even when information handling system 600 is powered off or powered to a standby state. BMC 660 may include a processor, memory, an out-of-band network interface separate from and physically isolated from an in-band network interface of information handling system 600, and/or other embedded information handling resources. In certain embodiments, BMC 660 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A multi-cluster management method, comprising:
maintaining an available resource pool comprising one or more resources available for use in at least one cluster selected from a plurality of clusters corresponding to a multi-cluster environment;
detecting a request for multi-cluster management, wherein the request indicates a multi-cluster management task;
analyzing the request to identify needed resources, if any, required for the multi-cluster management task;
determining whether the available resource pool includes sufficient suitable resources for the needed resources, if any; and
responsive to determining the available resource pool includes sufficient suitable resources, performing the multi-cluster management task, wherein said performing includes:
allocating a selected resource from the available resource pool to a targeted cluster; and
removing the selected resource from the available resource pool.

2. The method of claim 1, wherein said performing includes initializing an available resource for use as a new node in a targeted cluster selected from the plurality of clusters.

3. The method of claim 2, wherein said initializing includes installing an operating system suitable for the new node within the targeted cluster.

4. The method of claim 3, wherein the operating system suitable for the new node within the targeted cluster differs from an operating system for an existing node in the targeted cluster.

5. The method of claim 2, wherein said initializing includes configuring the node in accordance with cluster-specific provisioning criteria.

6. The method of claim 5, wherein the cluster-specific provisioning criteria include at least one of:
cluster-specific compute requirements;
cluster-specific storage requirements;
cluster-specific network requirements; and
cluster-specific configuration options.

7. The method of claim 1, wherein the multi-cluster management task comprises an add-node task to add a node to an existing cluster.

8. The method of claim 1, wherein the multi-cluster management task comprises a remove-node task to remove an existing node from an existing cluster.

9. The method of claim 1, wherein the multi-cluster management task comprises a create-cluster task to create a new cluster and wherein the create-cluster task includes building a new cluster control plane for connecting to nodes allocated to the new cluster.

10. The method of claim 1, wherein the multi-cluster environment includes at least one cluster implemented in a hyperconverged infrastructure (HCI) appliance.

11. An information handling system, comprising:
a central processing unit (CPU); and
a system memory, accessible to the CPU, including processor-executable instructions that, when executed by the CPU, cause the system to perform multi-cluster management operations, comprising:
maintaining an available resource pool comprising one or more resources available for use in at least one cluster selected from a plurality of clusters corresponding to a multi-cluster environment;
detecting a request for multi-cluster management, wherein the request indicates a multi-cluster management task;
analyzing the request to identify needed resources, if any, required for the multi-cluster management task;
determining whether the available resource pool includes sufficient suitable resources for the needed resources, if any; and
responsive to determining the available resource pool includes sufficient suitable resources, performing the multi-cluster management task, wherein said performing includes:
allocating a selected resource from the available resource pool to a targeted cluster; and
removing the selected resource from the available resource pool.

12. The information handling system of claim 11, wherein said performing includes initializing an available resource for use as a new node in a targeted cluster selected from the plurality of clusters.

13. The information handling system of claim 12, wherein said initializing includes installing an operating system suitable for the new node within the targeted cluster.

14. The information handling system of claim 13, wherein the operating system suitable for the new node within the targeted cluster differs from an operating system for an existing node in the targeted cluster.

15. The information handling system of claim 12, wherein said initializing includes configuring the node in accordance with cluster-specific provisioning criteria.

16. The information handling system of claim 15, wherein the cluster-specific provisioning criteria include at least one of:
cluster-specific compute requirements;
cluster-specific storage requirements;
cluster-specific network requirements; and
cluster-specific configuration options.

17. The information handling system of claim 11, wherein the multi-cluster management task comprises an add-node task to add a node to an existing cluster.

18. The information handling system of claim 11, wherein the multi-cluster management task comprises a remove-node task to remove an existing node from an existing cluster.

19. The information handling system of claim 11, wherein the multi-cluster management task comprises a create-cluster task to create a new cluster and wherein the create-cluster task includes building a new cluster control plane for connecting to nodes allocated to the new cluster.

20. The information handling system of claim 11, wherein the multi-cluster environment includes at least one cluster implemented in a hyperconverged infrastructure (HCI) appliance.
